(19) United States
(12) Patent Application Publication
(10) Pub. No.: US 2014/0063048 A1
(43) Pub. Date: Mar. 6, 2014

(54) VISUAL ACCESSIBILITY INDICATORS

(71) Applicants: Richard J. SOMERFIELD, Cheshire (GB); Paul K. BRANTON, Rochdale (GB); Andrew J. SMITH, London (GB)

(72) Inventors: Richard J. SOMERFIELD, Cheshire (GB); Paul K. BRANTON, Rochdale (GB); Andrew J. SMITH, London (GB)

(73) Assignee: APPSENSE LIMITED, Warrington (GB)

(21) Appl. No.: 13/604,973

(22) Filed: Sep. 6, 2012

(51) Int. Cl. G09G 5/00

(52) U.S. Cl. 345/619

(57) ABSTRACT

Systems and methods are described for providing visual accessibility indicators on mobile devices. A computerized method of presenting a visual accessibility indicator relating to a target file includes detecting, using a mobile device, an active network connection of the mobile device to be used to transfer the target file, retrieving a connection profile for the active network connection, the connection profile including attributes relating to the active network connection, projecting accessibility of the target file at least partially based on the connection profile, and displaying, on the mobile device, a visual accessibility indicator representing the projected accessibility, wherein the visual accessibility indicator contains an icon illustrating the accessibility.

### BACKGROUND

Mobile computing has become more and more popular in recent times. Many mobile devices are being used at various locations to access data stored on remote storage platforms. Determining the cost of access, however, can be a challenge in a mobile computing environment. The cost of accessing data remotely on a mobile device can depend on a number of factors, such as, the location of the mobile device, the connection of the mobile device to the mobile network and remote storage platform, and the location and size of the data to be accessed. Once the cost of accessing remote data is determined, presenting the information in a user-friendly way presents additional challenges.

### SUMMARY

In accordance with the disclosed subject matter, systems and methods are described for providing visual accessibility indicators on mobile devices.

Disclosed subject matter includes, in one aspect, a computerized method of presenting a visual accessibility indicator relating to a target file, which includes detecting, using a mobile device, an active network connection of the mobile device to be used to transfer the target file, retrieving a connection profile for the active network connection, the connection profile including attributes relating to the active network connection, projecting accessibility of the target file at least partially based on the connection profile, and displaying, on the mobile device, a visual accessibility indicator representing the projected accessibility, wherein the visual accessibility indicator contains an icon illustrating the accessibility.

In some embodiments, the computerized method of claim further includes creating, on the mobile device, a connection profile for the active network connection if one does not exist.

In some other embodiments, the computerized method of claim further includes, if the active network connection already has a connection profile, updating the connection profile for the active network connection based on detected attributes of the active network connection.

In some other embodiments, the computerized method of claim further includes detecting another available network connection, and retrieving a connection profile for the another network connection.

In some other embodiments, the computerized method of claim further includes detecting whether the target file is available locally on the mobile device, displaying an indication that the target file is available locally on the mobile device when the target file is available locally, and displaying an indication that the target file is not accessible when the target file is not available locally on the mobile device and no active network connection is detected.

In some other embodiments, the visual accessibility indicator further contains a scale of accessibility, one end of the scale representing the target file is highly accessible and the other end of the scale representing the target file is not accessible, and the icon is positioned on the scale based on the accessibility of the target file.

In some other embodiments, the visual accessibility indicator contains a first icon representing the target file is available quickly when the accessibility is better than a first threshold value.

In some other embodiments, an opacity of the first icon is adjusted at least partially based on the accessibility and the first threshold value.

In some other embodiments, the opacity of the first icon is adjusted higher when the accessibility is further away from the first threshold value.

In some other embodiments, the visual accessibility indicator contains a second icon representing the target file is available slowly when the accessibility is worse than a second threshold value.

In some other embodiments, an opacity of the second icon is adjusted at least partially based on the accessibility and second threshold value.

In some other embodiments, the opacity of the second icon is adjusted higher when the accessibility is further away from the second threshold value.

In some other embodiments, the accessibility is based on the projected time of downloading the target file.

In some other embodiments, the accessibility is based on the projected data size of the target file.

In some other embodiments, the accessibility is based on the monetary cost of downloading the target file.

Disclosed subject matter includes, in another aspect, an apparatus which includes a processor and a memory coupled to the processor and including computer readable instructions that, when executed by the processor, cause the processor to: detect an active network connection to a mobile device to be used to transfer target data, retrieve a connection profile for the active network connection, the connection profile including attributes relating to the active network connection, project accessibility of the target data at least partially based on the connection profile, and cause the display, on the mobile device, a visual accessibility indicator representing the projected accessibility, wherein the visual accessibility indicator contains an icon illustrating the accessibility.

Disclosed subject matter includes, in yet another aspect, a non-transitory computer readable medium having executable instructions operable to, when executed by a computer, cause the computer to: detect an active network connection to a mobile device to be used to transfer target data, retrieve a connection profile for the active network connection, the connection profile including attributes relating to the active network connection, project accessibility of the target data at least partially based on the connection profile, and cause the display, on the mobile device, a visual accessibility indicator representing the projected accessibility, wherein the visual accessibility indicator contains an icon illustrating the accessibility.

Various embodiments of the subject matter disclosed herein can provide one or more of the following capabilities. A mobile device can present the user a user-friendly and intuitive visual indicator illustrating the accessibility of a target file. Before the download starts or during the download, the user can see and understand in real-time the cost associated with downloading data/files at a glance. When the target data/file is inaccessible, the user can be notified before the download starts, therefore saving time and resources. When the target data/file is available locally, the user can be notified before the download starts, therefore again saving time and resources. When a network connection is available for downloading a target file, the user can be presented with the real-time accessibility before and during the download, therefore enabling the user to make an informed decision whether to start or continue the download. When multiple network connections are available to download a target file, the user can be presented with the accessibility of the target file over each available connection, therefore enabling the user to make an informed decision whether to switch to a different connection.

These and other capabilities of the invention, along with the invention itself, will be more fully understood after a review of the following figures, detailed description, and claims.

### BRIEF DESCRIPTION OF THE DRAWINGS

FIG. 1 illustrates a diagram of an exemplary networked communication system.

FIG. 2 illustrates a block diagram of an exemplary system for providing visual accessibility indicators.

FIG. 3 illustrates an exemplary process of providing visual accessibility indicators.

FIGS. 4A-4C illustrate in details one example of presenting visual accessibility indicators.

FIG. 5 illustrates a block diagram of an exemplary computing system in.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are only examples, and that it is contemplated that there are other systems and methods that are within the scope of the disclosed subject matter.

Embodiments of the disclosed subject matter provide techniques for providing a visual accessibility indicator so that a user can determine, at a glance, a cost associated with downloading or uploading information over a network connection. The visual accessibility indicator can take into account various factors such as the size of the data to be transmitted, the attributes of the network connection, and a monetary cost associated with transmitting data. The visual accessibility indicator can use these various factors to derive, and display to a user, an easy, and intuitive indicator of the cost associated with downloading or uploading data. The visual accessibility indicator can also be modified to reflect different “costs” that are relevant to specific users (e.g., monetary cost, time cost). Other embodiments are within the scope of the invention.

Some systems can obtain the size of target data/file, e.g., via metadata requests, and present the information to the user before actually downloading the target data/file from a remote platform. The user can decide whether to download the target data based on the size information presented. The size information presented by those systems, however, can be too technical for many users to understand and in many situations does not sufficiently inform the users about the true cost to download the data/file. For example, an average user may not understand what a file size of 100 MB implicates in terms of the downloading time. Downloading a 100 MB file over a high-speed WI-FI connection can be much faster than downloading the same file over a low-speed 3G network. In this context “cost” can be more than just a monetary value (e.g., it can include time, size, bandwidth, risk, etc.)

Given their mobile nature, mobile devices can be continually connecting to and disconnecting from different networks (e.g., Wifi, 4G, 3G, LTE, EDGE, handoff, etc.). The switching of network connections can occur within a short period of time and within a small physical region. The switching of network connections can very well occur while a file is being downloaded from a remote source. Even if a downloading time is somehow determined and presented to the user at the start of the downloading, the information is likely static and can become outdated once a switch of network connection occurs. In many situations, mobile users would prefer more accurate information about the download presented in a user-friendly way so that they can make informed decisions (e.g., continue to download or cancel the download).

The techniques disclosed in this document can provide a visual indicator informing the users of the accessibility of the target data/file. The visual accessibility indicators are presented in a user-friendly way and can provide both accurate and real-time accessibility information to the user.

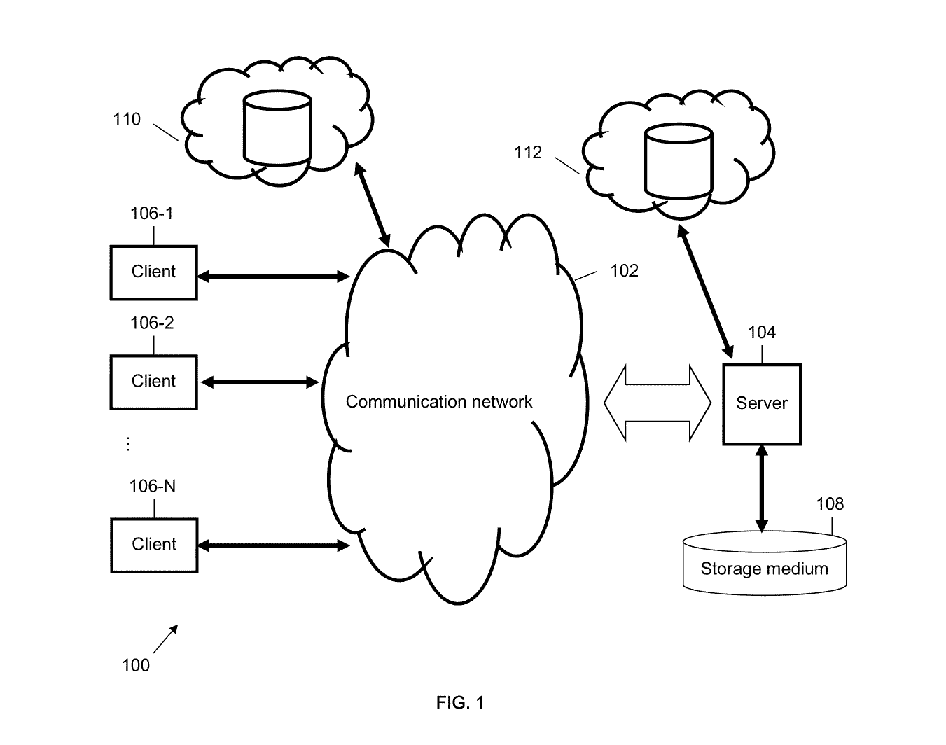

The disclosed subject matter can be implemented in a networked computing system. FIG. 1 illustrates a diagram of a networked communication arrangement 100 in accordance with an embodiment of the disclosed subject matter. The networked communication arrangement 100 can include a communication network 102, a server 104, and at least one client 106 (e.g., client 106-1, 106-2, . . . 106-N), a physical storage medium 108, and a cloud storage 110 and 112.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include a desktop computer, a mobile computer, a tablet computer, a cellular device, or any computing systems that are capable of performing computation.

Server 104 can be coupled to at least one physical storage medium 108, which is configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. FIG. 1 shows one cloud storage 110 and one cloud storage 112; however, more than one cloud storage 110, more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 102 as a single network; however, the network 102 can include multiple interconnected networks listed above.

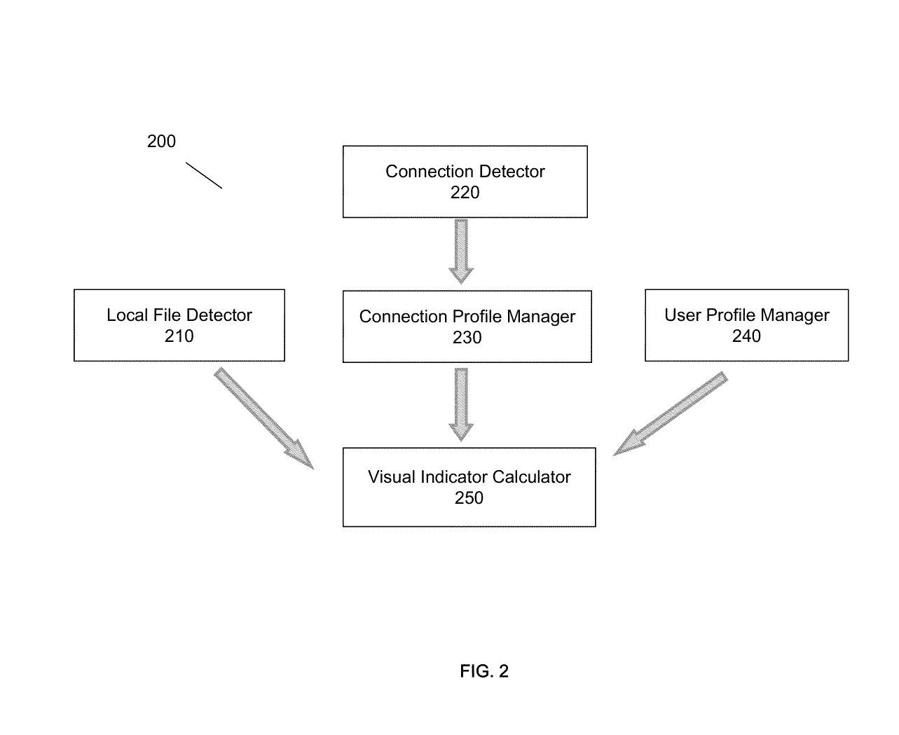

FIG. 2 illustrates a block diagram of a system that can provide visual accessibility indicators in accordance with certain embodiments of the disclosed subject matter. A visual accessibility indicator system 200 can include a local file detector 210, a connection detector 220, a connection profile manager 230, a user profile manager 240, and a visual indicator calculator 250. In some embodiments, the visual accessibility indicator system 200 can be implemented locally in a client 106. For example, a client 106 can itself include all the components of the visual accessibility indicator system 200 and can perform all the functions described herein locally. In other embodiments, the visual accessibility indicator system 200 can be implemented in a centralized manner in the networked communication arrangement 100. For example, a server 104 can contain all the components of the system 200 and perform all the functions described herein based on the information received from a client 106. In still other embodiments, the visual accessibility indicator system 200 can be implemented in a distributed manner across the networked communication arrangement 100. For example, a client 106 can contain the local file detector 210 and the connection detector 220, while a server 104 can contain the connection profile manager 230, the user profile manager 240, and the visual indicator calculator 250. Information to/from various components can be communicated over the communication network 102 in the networked communication arrangement 100. Various physical arrangements of the components within the visual accessibility indicator system 200 are possible and do not affect the functionality of the visual accessibility indicator system 200 described herein.

In response to detecting that a user may want to download a target file (or data), the local file detector 210 can detect if the target file exists locally and is therefore readily available without downloading. For example, the target file may have been created on the local device in the first place, or the file could have been cached locally from a previous request. The local file detector 210 can interact with the underlying file system on the local device to detect the existence of the target file. The local file detector 210 can be configured to check some specific locations on the local file system, e.g., the “My Favorite” directory, the “My Downloads” directory, the system/user cache directory, etc. The local file detector 210 can pass the local file detection result to other components (e.g., the visual indicator calculator 250) of the system 200.

The connection detector 220 can detect whether a mobile device (e.g., a client 106) is currently connected to a remote network (e.g., the communication network 102 or the Internet). If a connection is detected, the connection detector 220 can also try to determine the attributes of the connection (e.g., name, location, speed, latency, bandwidth, security, utilization, congestion, reliability) or any restrictions. One exemplary way of determining the attributes of the connection is by measuring the response times through a PING command. Another exemplary way is by transmitting test data and measuring the test result to determine bandwidth. Other methods of determining connection attributes are also possible. The connection detector 220 can continuously monitor the status of multiple connections in real-time. For example, the connection detector 220 can detect any changes in the attributes of the currently active connection; it can also determine the existence of other available connections and detect their respective attributes (e.g., some mobile devices can be connected simultaneously cellular and WI-FI networks). Alternatively, the connection detector 220 can be configured to receive notifying events from the underlying system once a new network connection is established and/or an existing network connection is changed. The connection detector 220 can also be configured to detect when attributes of an existing network change (e.g., the connection speed slows down). Once a new or changed connection is detected, the connection detector 220 can notify other components of the visual accessibility indicator system 200, which can then react accordingly. The connection detector 220 can also be configured to switch the mobile device from one connection to the other, e.g., based on a user's preferences.

The connection profile manager 230 can be configured to manage connection profiles relating to connections that are (or can be) available. For example, the connection profile manager 230 can interact with the connection detector 220 to determine if a detected connection already has a profile associated with it. A connection profile can be a file that contains various information, such as the profile ID, the connection attributes (e.g., bandwidth, speed, latency), the identification and/or location of the requesting device, the identification and/or location of the remote device, the identifications and/or locations of any routing devices, and cost, etc. If a detected connection does not have an associated profile, the connection profile manager 230 can create a profile for this newly detected connection. If the detected connection already has an associated profile, the connection profile manager 230 can update the existing profile to reflect the real-time/current attributes of the connection. The connection profile manager 230 can be configured to create/update profiles for the active connection only, detected but inactive connection(s) only, or both. The information about the currently active and available connections along with the corresponding connection profile information can be passed to other components (e.g., the visual indicator calculator 250) of the system 200. The connection profile manager 230 can be configured to store the profiles locally and/or at a remote location.

The information contained in each connection profile can come from different sources. For example, the visual accessibility indicator system 200 can provide a universal default connection profile for all connections. Or, the system 200 can provide a default connection profile for each type of connections (e.g., WIFI, 3G, LTE, etc.). The connection profile manager 230 can be configured to accept the default connection profile provided by the system 200 and optionally customize it to fit specific needs. The connection profile manager 230 can also be configured to create a connection profile from scratch for each available connection. The information in each profile can be aggregated from prior file transfers over a specific connection, can be provided from third parties, and or can be directly measured in certain circumstances.

The user profile manager 240 can manage many aspects of a profile of a mobile device user. A user profile can contain a unique user ID and the user's preferences. The user preferences can include whether the mobile device should automatically switch to a faster/better connection, whether existing connection profiles should be automatically updated, threshold values for visual accessibility indicators, customizable icons for visual accessibility indicators, etc. A default profile can be provided for users of the mobile device. A user can choose to either adopt the default profile or customize the default profile to fit any individual needs.

The visual indicator calculator 250 can provide a visual accessibility indicator based on the information received from the user and/or other components of the visual accessibility indicator system 200. For example, the projected download time of a target data/file can be calculated based on the profile of the active connection. Additionally, the projected download time can be calculated based on the current state of the active connection without its profile. More details about calculating and presenting visual accessibility indicators are provided below.

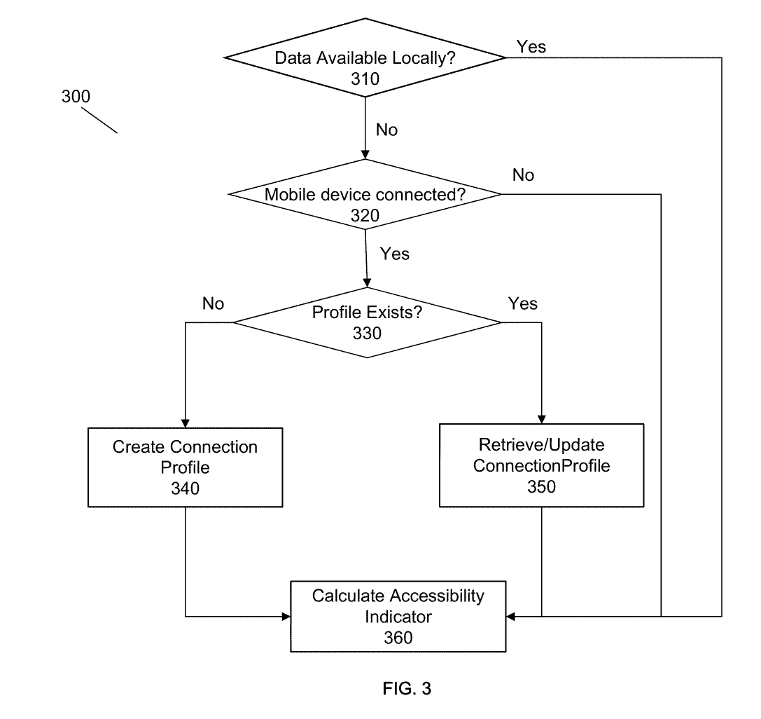

FIG. 3 illustrates one process of providing visual accessibility indicators in accordance with certain embodiments of the disclosed subject matter. The process 300 is exemplary only, and can include more or less steps as illustrated in FIG. 3. The steps in the process 300 can be altered and/or executed in the same or different sequences as illustrated in FIG. 3.

At step 310, the local file detector 210 can detect if a target data/file is already available locally on the mobile device. A target data/file may have already been downloaded to the mobile and/or could have been created on the mobile device. The local file detector 210 can interact with an underlying file system on the mobile device to detect the existence of the target data/file. The local file detector 210 can be configured to check some specific locations on the local file system, e.g., the “My Favorite” directory, the “My Downloads” directory, the system/user cache directory, etc. If the target data/file is available locally, the process 300 proceeds to step 360, otherwise the process 300 proceeds to step 320.

At step 320, the connection detector 220 can detect if the mobile device is currently connected to one or more networks. If no connection is detected, the target data/file can be considered inaccessible, and the process 300 proceeds to step 360. When a connection is detected, the connection detector 220 can determine the attributes of the connection(s), such as the bandwidth/speed. The connection detector 220 can continuously monitor the status of multiple connections and can trigger the repeat of some or all steps in process 300 when a new connection is detected or an existing connection has changed. Alternatively, the connection detector 220 can be configured to receive notifying events from the underlying system once a new or changed connection is detected.

At step 330, the connection profile manager 230 receives information about a connection from the connection detector 220 and determines if the connection already has a profile associated with it. The connection profile manager 230 can be configured to determine if an existing profile exists using a network ID, network name, or any other identifier. If a connection profile exists for the connection, the process 300 proceeds to step 350, otherwise the process 300 proceeds to step 340.

At step 340, the connection profile manager 230 creates a profile based on the information determined by the connection detector 220 and/or other information received from other components of system 200 and/or from the user of the mobile device. For example, the connection profile manager 230 can create a profile that identifies attributes of a connection such as name, location, speed, latency, bandwidth, security, utilization, congestion, reliability, etc.

At step 350, the connection profile manager 230 retrieves the existing connection profile. The connection profile manager 230 can also be configured to update the existing connection profile based on the information received from the connection detector 220.

At step 360, the visual indicator calculator 250 calculates a visual accessibility indicator based on one or more pieces of information received from other components of the system 200 and/or the user of the mobile device. For example, in addition to the attributes (e.g., bandwidth) of the active connection, the visual indicator calculator 250 can obtain the information (e.g., size) about the target data/file from other components of the system 200, request the target data/file information directly from the remote resources, or receive the target data/file information from the user. The visual indicator calculator 250 can also be configured to retrieve the user profile from the user profile manager 240 and use the user preferences (e.g., upper/lower bound/threshold values) in the user profile in its calculation of visual accessibility indicators.

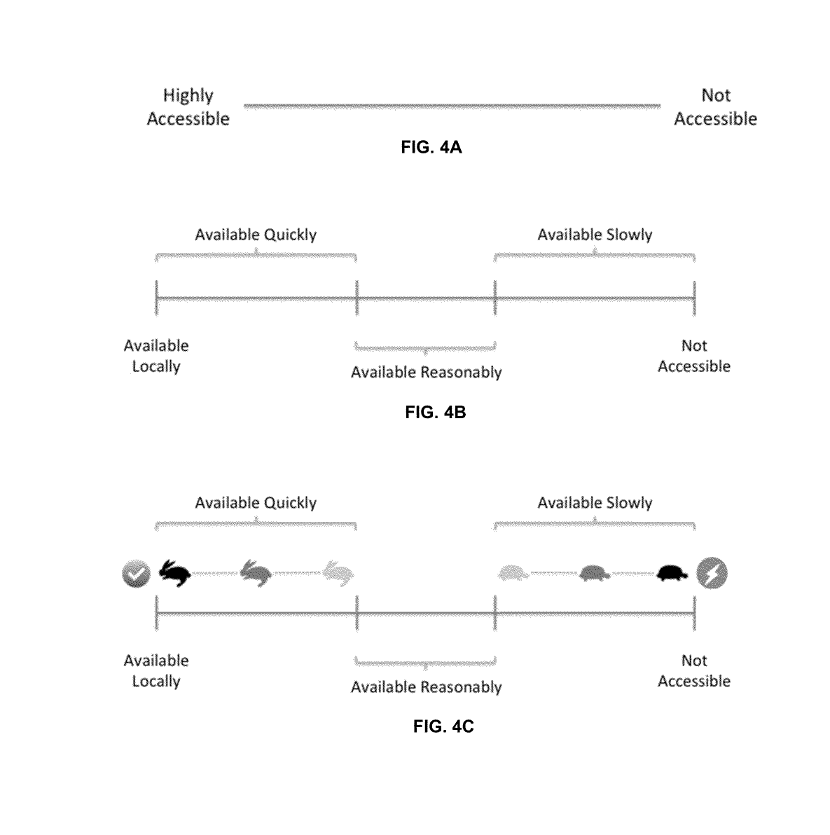

FIGS. 4A-4C illustrate in details one example of presenting visual accessibility indicators in accordance with certain embodiments of the disclosed subject matter. A sliding scale, as in FIG. 4A, can be used to illustrate the relative accessibility of a target data/file. One end of the scale can represent that the target data/file is highly accessible, while the other end can represent that the target data/file is inaccessible.

The accessibility scale can also be sub-divided into accessibility zones. For example referring to FIG. 4B, five different zones are shown: Available Locally (e.g., the target data/file is already on the local device.), Available Quickly (e.g., the target data/file can be downloaded relatively quickly.), Available Reasonably (e.g., the target data/file can be downloaded in a reasonable time.), Available Slowly (e.g., the target data/file can be downloaded but it can take some time.), and Not Accessible (e.g., there is no available connection to the target data/file.). The number of different accessibility zones and how they are sub-divided can be pre-set by the visual accessibility indicator system 200 and/or customized by the user. The accessibility scale marked with the current accessibility can be configured to be displayed to the user, providing an intuitive and user-friendly indication of the accessibility of the target data/file.

Optionally, as illustrated in FIG. 4C, for each accessibility zone, one or more visual indicators (e.g., icons) can be used to help demonstrate accessibility. As one example, a green checkmark icon can be displayed to the user if the accessibility falls into the Available Locally zone (e.g., the target data/file is already on the local device.). As another example, a broken link icon can be displayed to the user if the accessibility falls into the Not Accessible zone (e.g., the target data/file is not accessible.). If the accessibility falls into the Available Quickly zone, a self-explanatory icon (e.g., an image of a rabbit) can be displayed to the user. If the accessibility falls into the Available Slowly zone, another self-explanatory icon (e.g., an image of a turtle) can be displayed to the user. Optionally, the opacity (e.g., in the range of 0.0-1.0, with 1.0 being the most opaque) of the self-explanatory icon can be adjusted automatically dependent upon the relative accessibility within a particular zone. For example, the rabbit icon can become increasingly opaque as the accessibility improves within the Available Quickly zone, the turtle icon can become increasingly opaque when the accessibility deteriorates within the Available Slowly zone. An example algorithm of calculating and presenting visual accessibility indicators is described in Table 1 below.

TABLE 1
An example algorithm of calculating and presenting visual accessibility indicators.

| Projected Accessibility | Zone | Icon | Opacity (0.0-1.0) |
|---|---|---|---|
| The target data/file is on the | Available Locally | Green | 1.0 |
| local device. | | Check | |
| | | and/or | |
| | | Rabbit | |
| The target data/file is not on the | Available Quickly | Rabbit | 1.0-(Projected |
| local device. | (Lower Bound = 0 s; | | Download Time/ |
| The projected download | Upper Bound = 10 s) | | (Upper Bound − |
| time is <=10 s. | | | Lower Bound)) |
| The target data/file is not on | Available Reasonably | None | N/A |
| the local device. | (Lower Bound = 10 s; | | |
| The projected download | Upper Bound = 40 s) | | |
| time is >10 s and <=40 s. | | | |
| The target data/file is not on | Available Slowly | Turtle | 1.0-((Projected |
| the local device. | (Lower Bound = 40 s; | | Download Time − |
| The projected download | Upper Bound = 180 s) | | Lower Bound)/ |
| time is >40 s and <=180 s. | | | (Upper Bound − |
| | | | Lower Bound)) |
| The target data/file is not on | Available Slowly | Turtle | 1.0 |
| the local device. | (Lower Bound = 180 s; | | |
| The projected download | Upper Bound = ∞) | | |
| time is >180 s. | | | |
| The target data/file is not on | Not Accessible | Broken | 1.0 |
| the local device. | | Link | |
| No available network | | | |
| connection to the target | | | |
| data/file. | | | |

The visual accessibility indicator system 200 can be configured to display the accessibility scale without icon(s), the accessibility scale with icon(s), or the accessibility icon(s) itself without the scale. The visual accessibility indicator (e.g., scale and/or icon) can be configured to displayed to the user (e.g., next to the name of the target data/file) before the download starts. Additionally and optionally, the visual accessibility indicator (e.g., scale and/or icon) can be configured to be displayed to the user during the download.

Before and/or during the download, the visual accessibility indicator system 200 can be configured to continuously calculate the accessibility of the target data/file and update the accessibility scale and/or icon accordingly. As an example, as discussed above, when the attributes of the active connection change or when the device is switched to a different connection, the visual accessibility indicator system 200 can re-calculate the accessibility level and notify the user. As another example, when a user changes the user preferences in their user profile (e.g., the lower/upper bound of the Available Slowly zone), the visual accessibility indicator system 200 can re-calculate the appropriate accessibility icon accordingly.

The visual accessibility indicator system 200 can also be configured to monitor and provide feedback for multiple active network connections at the same time. For example, the visual accessibility indicator system 200 can be configured to calculate multiple visual accessibility indicators (e.g., one for each active connection) and display them to a user so that a user can select a particular connection to download a target file/data. The visual accessibility indicator system 200 can also calculate a visual accessibility indicator for other available connections in the background before any of the other available connections becomes the active connection.

As discussed above, a user can configure preferences in their profile defining how the visual accessibility indicator system 200 handles multiple network connections. For example, a user can have a preference that the visual accessibility indicator system 200 i) should ignore a better connection if one becomes available, ii) switch to a better connection automatically, if one becomes available, and/or iii) prompt the user to pick a desired connection if multiple network connection are available and/or become available. When the device prompts the user to select a different connection, the visual accessibility indicator corresponding to the accessibility of the target data/file over the new connection can be presented to the user. In this way, the user can make an informed decision based on the user-friendly representation of the accessibility.

The cost of download can be multi-fold. In one aspect, it can mean the time required to complete a download. For example, a download lasting 20 seconds can be considered more costly than one lasting 10 seconds. In other aspect, it can mean the absolute size of the download. For example, a download of a 20 MB file can be considered more costly than one of a 10 MB file. This is especially relevant when a data quota is imposed by, for example, a service provider. In another aspect, it can mean the monetary cost of the download. For example, a download of a 1 GB file over a connection where surcharges apply starting at 500 MB can be much more costly than over a different connection where surcharges apply starting at 2 GB. Thus, “cost” is a broad term and is not limited to a monetary cost.

When a mobile device user is more concerned about the absolute size or monetary cost of download, the visual accessibility indicator system 200 can be configured to calculate and present the visual indicators in a way that provide useful information to the mobile device users. As an example, the accessibility scale, as illustrated in FIG. 4A, can be updated so that one end represents less expensive and the other end represents more expensive. As another example, the accessibility scale, as illustrated in FIG. 4C, can be updated so that one end is labeled with a big dollar sign representing “very expensive” and the other end is labeled with a penny sign representing “not inexpensive.” As discussed above, how the accessibility scale is sub-divided into zones and what icons are used can be system, and/or user-configurable.

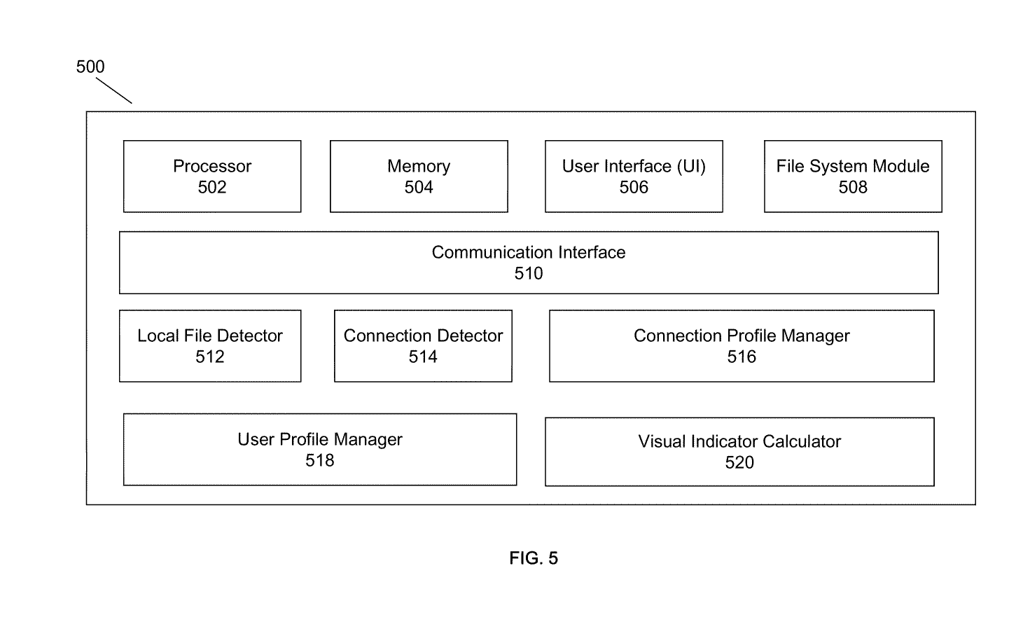

FIG. 5 illustrates a block diagram of a computing system that can be used to implement one or more aspects of the functionality described herein. The computing system 500 can serve as, for example, a client 106, a server 104, or both in the networked communication arrangement 100. The computing system 500 can include at least one processor 502 and at least one memory 504. The processor 502 can be hardware that is configured to execute computer readable instructions such as software. The processor 502 can be a general processor or be an application specific hardware (e.g., an application specific integrated circuit (ASIC), programmable logic array (PLA), field programmable gate array (FPGA), or any other integrated circuit). The processor 502 can execute computer instructions or computer code to perform desired tasks. The memory 504 can be a transitory or non-transitory computer readable medium, such as flash memory, a magnetic disk drive, an optical drive, a programmable read-only memory (PROM), a read-only memory (ROM), or any other memory or combination of memories.

The computing system 500 can also include a user interface (UI) 506, a file system module 508, and a communication interface 510. The UI 506 can provide an interface for users to interact with the computing system 500 in order to provide and/or receive data to/from users. The file system module 508 can be configured to maintain a list of all data files, including both local data files and remote data files, in every folder in a file system. The file system module 508 can also be configured to maintain a list of all remote files that have previously been downloaded. The file system module 508 can be further configured to coordinate with the memory 504 to store local data files, remote data files that have been downloaded from a remote server, information about the data files, such as metadata, and any other suitable information about the data files. The communication interface 510 can allow the computing system 500 to communicate with external resources (e.g., a network or a remote client/server).

The computing system 500 can also include a local file detector 512, a connection detector 514, a connection profile manager 516, a user profile manager 518, and a visual indicator calculator 520. The description of these components and their functionalities can be found in the description of their counterparts in FIG. 2. The local file detector 512, the connection detector 514, the connection profile manager 516, the user profile manager 518, and the visual indicator calculator 520 can be implemented in software and/or hardware. They can be implemented as separate components or as one or more indistinguishable components. In some embodiments, the computer system 500 can include additional modules, fewer modules, or any other suitable combination of modules that perform any suitable operation or combination of operations.

The disclosed systems and methods, as illustrated by examples above, can provide users of mobile devices accurate, up-to-date, and user-friendly information about accessibility of target data/file.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

While the foregoing description has primarily been described in the context of a wireless device downloading information via a wireless connection, the present disclosure can also be used with wired connections and/or non-mobile devices. In addition, the present disclosure can also be used in the context of uploading information via a wired or wireless connection, and to provide a “cost” associated with uploading information to a remote device. While the foregoing description describes displaying a visual indicator relating to the download of “files,” the disclosure is not so limited. For example, the visual indicator can relate to raw data, pieces of files, multiple files, etc.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method of presenting a visual accessibility indicator relating to a target file, the method comprising:
detecting, using a mobile device, an active network connection of the mobile device to be used to transfer the target file;
retrieving a connection profile for the active network connection, the connection profile including attributes relating to the active network connection;
projecting accessibility of the target file at least partially based on the connection profile; and
displaying, on the mobile device, a visual accessibility indicator representing the projected accessibility, wherein the visual accessibility indicator contains an icon illustrating the accessibility.

2. The computerized method of claim 1, further comprising creating, on the mobile device, a connection profile for the active network connection if one does not exist.

3. The computerized method of claim 1 further comprising:
if the active network connection already has a connection profile, updating the connection profile for the active network connection based on detected attributes of the active network connection.

4. The computerized method of claim 1 further comprising:
detecting another available network connection; and
retrieving a connection profile for the another network connection.

5. The computerized method of claim 1 further comprising:
detecting whether the target file is available locally on the mobile device;
displaying an indication that the target file is available locally on the mobile device when the target file is available locally; and
displaying an indication that the target file is not accessible when the target file is not available locally on the mobile device and no active network connection is detected.

6. The computerized method of claim 1 wherein the visual accessibility indicator further contains a scale of accessibility, one end of the scale representing the target file is highly accessible and the other end of the scale representing the target file is not accessible, and the icon is positioned on the scale based on the accessibility of the target file.

7. The computerized method of claim 1 wherein the visual accessibility indicator contains a first icon representing the target file is available quickly when the accessibility is better than a first threshold value.

8. The computerized method of claim 7 wherein an opacity of the first icon is adjusted at least partially based on the accessibility and the first threshold value.

9. The computerized method of claim 8 wherein the opacity of the first icon is adjusted higher when the accessibility is further away from the first threshold value.

10. The computerized method of claim 1 wherein the visual accessibility indicator contains a second icon representing the target file is available slowly when the accessibility is worse than a second threshold value.

11. The computerized method of claim 10 wherein an opacity of the second icon is adjusted at least partially based on the accessibility and second threshold value.

12. The computerized method of claim 11 wherein the opacity of the second icon is adjusted higher when the accessibility is further away from the second threshold value.

13. The computerized method of claim 1 wherein the accessibility is based on the projected time of downloading the target file.

14. The computerized method of claim 1 wherein the accessibility is based on the projected data size of the target file.

15. The computerized method of claim 1 wherein the accessibility is based on the monetary cost of downloading the target file.

16. An apparatus comprising:
a processor; and
a memory coupled to the processor and including computer readable instructions that, when executed by the processor, cause the processor to:
detect an active network connection to a mobile device to be used to transfer target data;
retrieve a connection profile for the active network connection, the connection profile including attributes relating to the active network connection;
project accessibility of the target data at least partially based on the connection profile; and
cause the display, on the mobile device, a visual accessibility indicator representing the projected accessibility, wherein the visual accessibility indicator contains an icon illustrating the accessibility.

17. A non-transitory computer readable medium having executable instructions operable to, when executed by a computer, cause the computer to:
detect an active network connection to a mobile device to be used to transfer target data;
retrieve a connection profile for the active network connection, the connection profile including attributes relating to the active network connection;
project accessibility of the target data at least partially based on the connection profile; and
cause the display, on the mobile device, a visual accessibility indicator representing the projected accessibility, wherein the visual accessibility indicator contains an icon illustrating the accessibility.
